(19) United States
(12) Patent Application Publication
(10) Pub. No.: US 2008/0148936 A1
(43) Pub. Date: Jun. 26, 2008

(54) Composite structured adsorbents

(76) Inventor: Mohamed Safdar Allie Baksh, Wheatfield, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/644,287

(22) Filed: Dec. 22, 2006

(51) Int. Cl. B01D 53/22; B01D 53/047

(52) U.S. Cl. 95/47; 95/148; 95/53; 95/55; 95/95; 96/153; 96/154

(57) ABSTRACT

The present invention relates to composite structured adsorbents and methods of use therefor. The invention more particularly relates to composite structured adsorbents that can include a multi-channel framework (e.g., monoliths), the channels of the multi-channel framework containing adsorbent beads particles therein, with a channel-to-particle diameter ratio in the range of 1 to 10, more preferably 1 to 7 and even more preferably 1 to 5. In the case of non-spherical particles, the hydraulic diameter is used in the calculation of the channel-to-particle diameter. The composite structured adsorbents of the present invention can be used in various industrial applications, for example in pressure swing adsorption (PSA) or vacuum pressure swing adsorption (VPSA) processes to produce O₂ from air.

### TECHNICAL FIELD

The present invention relates to composite structured adsorbents (CSAs) and methods of use therefor. The invention more particularly relates to composite structured adsorbents that include a multi-channel framework (e.g., monoliths), the channels of the multi-channel framework containing adsorbent beads or particles therein, with a channel-to-particle diameter ratio in the range of 1 to 10, more preferably 1 to 7 and even more preferably 1 to 5. In the case of non-spherical particles, the hydraulic diameter is used in the calculation of the channel-to-particle diameter. The composite structured adsorbents of the present invention can be used in various industrial applications, for example in pressure swing adsorption (PSA) or vacuum pressure swing adsorption (VPSA) processes to produce O₂ from air.

### BACKGROUND OF THE INVENTION

Gas separation processes such as commercial fixed bed pressure swing adsorption (PSA) processes or vacuum pressure swing adsorption (VPSA) processes generally use granular or pelletized adsorbents in randomly packed (i.e., fixed) beds. In some instances, however, structured adsorbents have been considered for use in gas separation processes to achieve lower bed pressure drop over packed beds of random adsorbent particles. In structured adsorbents (e.g., monoliths) however, much less adsorbent material has been exposed to the flow of gas being processed, thereby resulting in lower mass transfer coefficient (MTC) per unit length and a concomitant degradation of the desired product (e.g., O₂) purity relative to randomly packed beds of pelletized adsorbents. While randomly packed beds of adsorbent particles have not necessarily been the most efficient manner of packing for adsorber beds, the choice of using a random arrangement of adsorbent particles has generally remained the least expensive and easiest option relative to structured adsorbents.

In some applications or processes, shorter process cycle times may be desirable. For example, shorter process cycle times may result in lower capital cost where smaller adsorption beds are used to achieve smaller adsorbent inventory and a smaller PSA/VPSA system footprint. The shorter cycle times, however, could result in higher power consumption or operating cost, thus requiring consideration between capital cost and operating cost. The balance between operating cost and capital cost can be case specific, i.e., there may be instances when a small system footprint is a necessity, for example in an integrated power plant having limited space for additional unit operation (e.g., VPSA O₂). In addition, there are times when operating cost (e.g., power) is more important than capital cost or PSA/VPSA valve reliability (shorter cycle times have sometimes resulted in pre-mature valve failure) becomes more important than lower capital cost. As the feed (e.g., air) throughput increases and the adsorption process becomes faster (shorter PSA cycle times), the pressure drop across a packed bed of adsorbent particles can become prohibitive and alternative adsorption bed configurations are needed.

In the past, monoliths have been considered as an alternative for high frequency PSA/VPSA processes. Monoliths are also used as catalyst supports with applications including automobile catalytic converters, catalytic combustion, electrochemical reactors, biochemical reactors and the like. Generally speaking, monoliths (i.e. monolithic structure) are single solid devices composed of many parallel channels that may be circular, hexagonal, square, triangular or sinusoidal in nature. Monoliths have been coated (e.g., washcoat monoliths or a honeycomb structure having adsorbent coated on the walls) and used in catalytic processes such as a selective catalytic reduction of nitrous oxide (e.g., NO) using ammonia. Monolithic adsorbents have been considered as a way to reduce concerns regarding fluidization of adsorbent in packed beds when operating at high flow rates.

Although the pressure drop per unit length of an adsorption bed (ΔP/L) can be much less with a monolithic bed than for a packed bed of particles, monolithic beds have typically led to inferior separation performance (e.g., lower O₂ purity for a given VPSA O₂ cycle and operating conditions, or higher bed size factor at a fixed O₂ purity) relative to packed beds of adsorbent particles or pellets used in PSA or VPSA O₂ processes. The analogy between momentum transfer and mass and heat transfer predicts that if the pressure drop is lower, then the rate of mass and heat transfer between the fluid and solids will likewise be lower. Thus, mass and heat transfer in structured packing (e.g., monoliths) will likely be more important concerns than in a traditional packed bed of adsorbent particles. For example, much less adsorbent material has in the past been exposed to the flow of fluid being processed with a monolithic bed relative to a packed bed of particles on a flow basis, e.g., tonnage of O₂ produced per day at a given O₂ purity or feed throughput. Typically, monoliths have had a much lower mass transfer coefficient per unit length (MTC/L) than packed beds. Consequently, there has been a compromise between improved pressure drop and diminished separation performance when considering adsorption beds containing structured adsorbents (e.g., monoliths) over adsorption beds containing packed beds of adsorbents in the form of particles or pellets.

In U.S. Pat. No. 7,032,894 B2 to Adusei et al., a device positioned upstream of a monolith bed for distributing fluid to a monolithic bed is disclosed. The device includes a plurality of flow channels stacked in order of decreasing diameter. The decreasing diameter flow channels successfully split a flow stream into multiple flow streams prior to the flow stream entering the monolithic bed.

A system for gas purification (e.g., air drying) using at least one rotary contactor (also known as an adsorbent wheel or desiccant wheel) in an adsorption process is disclosed in PCT Publication No.WO 2005/097298 A1 (published on Oct. 20, 2005, by Dunne et al). In addition, U.S. Pat. No. 6,692,626 B2 to Keefer et al. relates to the use of laminate structures for PSA processes.

U.S. Pat. No. 6,521,019 B2 to Jain et al. relates to PSA/VPSA processes using monolithic adsorbents of zeolite. U.S. Pat. No. 6,284,705 B1 to Park et al. discusses adsorptive monoliths including activated carbon for removing volatile organics from various fluid streams.

There remains a need in various industrial applications to develop more efficient processes having lower bed pressure drop and lower power consumption, without reducing the mass transfer coefficient per unit length relative to a packed bed of adsorbent particles.

### BRIEF SUMMARY OF THE INVENTION

The present invention relates to composite structured adsorbents (CSAs) and methods of using such CSAs in various industrial applications. The CSAs of the present invention are intended to achieve lower adsorbent bed pressure drop and lower power consumption without reducing the mass transfer coefficient per unit length relative to packed beds of adsorbent particles.

The present invention more specifically relates to CSAs having a multi-channel framework (e.g., a monolithic structure), the channels of the multi-channel framework containing adsorbent particles therein and having a channel-to-particle diameter ratio in the range of 1 to 10, more preferably 1 to 7 and even more preferably 1 to 5, in the case of spherical particles (e.g. spherical beads). Various other forms of adsorbent particles can likewise be used in accordance with the present invention. For example, non-spherical beads, granular particles, cylindrical particles or pellets are suitable for use as adsorbent particles within the channels of the multi-channel framework. In situations where the adsorbent particles are non-spherical, the channel-to-particle diameter ratio of 1 to 10, more preferably 1 to 7 and even more preferably 1 to 5 can be determined using a hydraulic diameter of the adsorbent particles.

The adsorbent particles positioned in the channels can form an array of particles extending along a portion or all of the lengths of the channels. As described herein, the cross-section of each channel may include one or more adsorbent particles, depending on the value of N, the gas being processed and the conditions of the application being used (e.g., PSA, VPSA, TSA, etc.). The adsorbent particles within the channels and the channels of the multi-channel framework are configured such that the channels function in a uniform and symmetrical manner with respect to the other channels in the framework. This is to ensure uniformity of product purity from each of the monolithic channels of the CSA structure to achieve desired process performance.

In one aspect of the present invention, the CSAs can be used in pressure swing adsorption (PSA) or vacuum pressure swing adsorption (VPSA) processes to produce O₂ from air. The CSA includes a multi-channel framework (e.g., a monolithic structure), the length of the channels of the framework being filled with adsorbent particles, with a channel-to-particle diameter ratio (N) in the range of 1 to 10, more preferably 1 to 7 and even more preferably 1 to 5. The use of CSAs in PSA or VPSA (PSA/VPSA) processes is expected to result in significantly lower pressure drop (e.g., up to a factor of 5-15) per unit mass relative to a randomly packed bed of particles or pellets containing the same mass. Furthermore, it is expected that an improvement of about 10-15% in O₂ recovery, and a 10-15% reduction in bed size factor and power consumption using CSAs in accordance with the present invention in some VPSA processes can be achieved relative to prior art adsorbers containing packed beds of beaded adsorbents. In accordance with the invention, composite structured adsorbent (CSA) materials may be particularly suitable for use in high frequency (i.e., VPSA cycle time<30 sec) PSA or VPSA processes to achieve improved PSA/VPSA performance relative to conventional packed beds of particles or monolithic beds. More specifically, the present invention may be suitable for use in high frequency (i.e., cycle time<30 sec) PSA or VPSA O₂ processes in which the PSA/VPSA beds preferably have one or more of the following: lower pressure drop per unit length, faster pressurization time, higher product recovery, lower bed size factor, and/or lower power consumption relative to PSA or VPSA processes using monolithic adsorbers or packed beds of particles or pellets.

Depending on the specific process being used, the gas being processed, the CSA material and the like, some of the technical advantages of CSA materials of the present invention over packed beds of beads or monoliths in some PSA/VPSA O₂ processes may include one or more of the following: (1) improved separation performance with respect to O₂ recovery at a given O₂ purity; (2) lower bed size factor (BSF); (3) lower power consumption; (4) improved external surface area per unit volume of adsorbent; (5) smaller temperature changes during pressure changing steps in some PSA/VPSA cycles; (6) lower external film resistance for mass transfer from the gas phase to the solid phase in some PSA/VPSA processes; (7) faster pressurization and depressurization times during the pressure changing steps of some PSA/VPSA cycles, resulting in a decrease in the total cycle time or an increase in O₂ productivity; (8) reduction in adverse temperature gradients in some PSA/VPSA beds, resulting in improved adsorbent utilization and bed differential loading during the adsorption and regeneration steps of the PSA/VPSA cycle; (9) CSA material resulting in a system with significantly lower pressure drop (e.g., up to a factor of 15) per unit mass relative to a randomly packed bed containing the same mass; (10) lower cell density monoliths could be used (lower cost) in the construction of CSA materials, and smaller beads could be packed in the monolith channels relative to packed bed of beads where the fluid path is highly tortuous, or (11) allowing for the use of smaller particles in the CSAs, yet at the same pressure drop as across a randomly packed bed, favoring adsorber efficiency and selectivity. One or more other advantages may also occur, depending on the specific process being used, the gas being processed, the CSA material and the like.

In other aspects of the invention, the CSAs of the invention can be used in conjunction with other industrial applications, such as for example temperature swing adsorption (TSA) processes, and rapid or fast super-atmospheric or trans-atmospheric PSA processes. For example and while not intending to be limiting, the CSAs of the invention may be suitable for use with H₂ PSA, VPSA and PSA O₂ production from air, steam iron processes, helium recovery from natural gas and the like.

### BRIEF DESCRIPTION OF THE DRAWINGS

For a more complete understanding of the present invention and the advantages thereof, reference is made to the following Detailed Description taken in conjunction with the accompanying drawings in which:

FIGS. 1(a)-1(c) show several examples of monolithic structures with various cell densities, void fractions, surface-to-volume ratios, and hydraulic diameters;

FIG. 2(a) shows an example of a multi-channel network of monoliths;

FIG. 2(b) illustrates an enlarged view of four channels in which the channels are packed with adsorbent particles;

FIG. 3(a) shows a cross-sectional view of four channels of a multi-channel monolithic structure in accordance with an embodiment of the present invention;

FIG. 3(b) shows an array of beads along the axis of one of the monolithic channels of FIG. 3(a);

FIG. 4 illustrates computational fluid dynamics (CFD) modeling results for one monolithic channel segment of a CSA material having one particle in the cross section of the channel and a plurality of particles stacked in a serial arrangement in the monolithic channel;

FIG. 5 illustrates a graphical representation of results of a computer simulation of a two-bed VPSA O₂ process comparing the use of monoliths, packed beds of beads, and CSA materials in each of the two beds;

FIG. 6(a) shows a comparison of the bed size factors (total pounds of adsorbents per ton per day O₂) for the two-bed process comparison using monolith, packed beds of beads, and CSA materials;

FIG. 6(b) shows a comparison of the corresponding power consumptions for the two-bed comparison using monolith, packed beds of beads, and CSA materials of FIG. 6(a);

FIG. 7 is a graphical representation showing the percentage change in O₂ recovery (Delta Rec.), bed size factor (Delta BSF) and power (Delta Pow) relative to packed beds of beads in the comparison of the two-bed VPSA O₂ process using monolith, packed beds of beads, and CSA materials;

FIGS. 8(a)-8(d) illustrate alternative embodiments of CSAs in accordance with the present invention; and

FIGS. 9(a)-9(c) show alternative embodiments of the present invention using a polylithic structure.

### DETAILED DESCRIPTION

As mentioned hereinabove, the present invention relates to composite structured adsorbents (CSAs) having a multi-channel framework (e.g., a monolithic structure), the channels of the multi-channel framework containing adsorbent particles therein and having a channel-to-particle diameter ratio in the range of 1 to 10, more preferably 1 to 7 and even more preferably 1 to 5, in the case of spherical particles (e.g. spherical beads). Various other forms of adsorbent particles can likewise be used in accordance with the present invention. For example, non-spherical beads, granular particles, cylindrical particles or pellets are suitable for use as adsorbent particles within the channels of the multi-channel framework. In situations where the adsorbent particles are non-spherical, the channel-to-particle diameter ratio of 1 to 10, more preferably 1 to 7 and even more preferably 1 to 5 can be determined using a hydraulic diameter of the adsorbent particles. As used herein, the hydraulic diameter (Dₕ) of non-spherical particles is defined as the ratio of four times the cross-sectional area divided by the wetted perimeter. One of ordinary skill in the art will know how to calculate the cross-sectional area and wetted perimeter. The porosity (i.e., the bed void fraction) of the CSA structures of the present invention are in the range of 0.3-0.8, preferably in the range of 0.3-0.6 and more preferably in the range of about 0.35-0.45.

In some embodiments, there may be only one particle in the cross-section of each channel and a plurality of particles stacked in a serial arrangement in each of the monolithic channels, thereby forming an array of particles within each channel. In other embodiments, there may be a plurality of particles in the cross-section of each channel and a plurality of particles also stacked in a serial arrangement in each monolithic channel, thereby forming an array of particles within each channel. The particles can be poured and packed into the channels of the monolithic structure to form the CSAs of the present invention. In some embodiments, the monolithic structure can be formed in segments and each segment can then be packed with the desired adsorbent particle configuration. The segments can then be arranged and joined together in a serial fashion for the desired length of the adsorber bed.

The CSAs of the present invention are further intended to achieve lower adsorbent bed pressure drop and lower power consumption without reducing the mass transfer coefficient per unit length relative to packed beds of adsorbent particles.

The composite structured adsorbents of the present invention are expected to be suitable for use in a variety of industrial applications, for example in pressure swing adsorption (PSA) and vacuum pressure swing adsorption (VPSA) processes to produce O₂ from air. In other aspects of the invention, the CSAs of the invention can be used in conjunction with other industrial applications, such as for example temperature swing adsorption (TSA) processes, rapid or fast super-atmospheric or trans-atmospheric processes. For example and while not intending to be limiting, the CSAs of the invention are expected to be suitable for use with H₂ PSA, VPSA and PSA O₂ production from air, steam iron processes, helium recovery from natural gas and the like.

The present invention recognizes that randomly packed beds of particles can result in high interstitial velocity and a fluid (e.g., gas) path that is tortuous, resulting in significant bed pressure drop and a concomitant increase in power consumption in VPSA O₂ processes. In addition, in packed beds of particles, the likelihood of particle fluidization becomes more probable with decreasing particle size or increasing inlet fluid velocity.

The present invention further recognizes that monolithic materials have previously been characterized by several disadvantages in connection with PSA/VPSA processes. For example, fluid entering the open channel of a monolith must first be transported to the wall of the monolith before adsorption takes place. Thus, transport from the gas phase to the solid surface of the monolith channel has affected the use of monolithic adsorbents in prior VPSA/PSA processes. Poor mass transport can cause a degradation of the product purity in the VPS/PSA process.

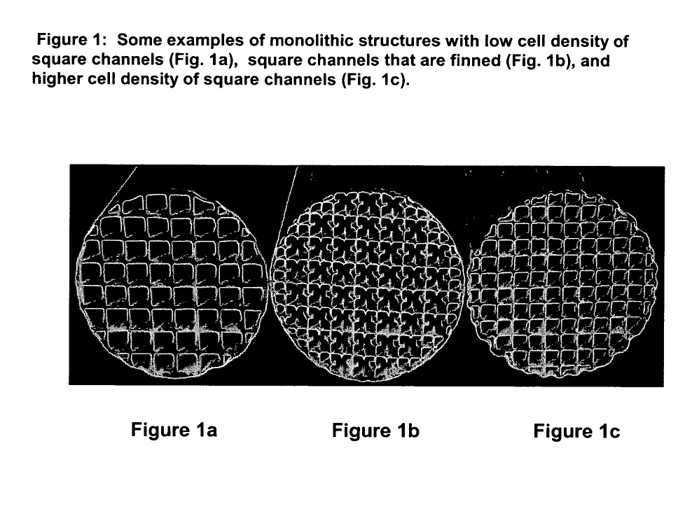

Attempts to improve the mass transfer from the gas phase to the solid surface of the monolith have in the past included increasing cell densities of the monolith. Referring now to FIGS. 1(a)-1(c), several examples of monolithic structures with different cell density (cells per square inch (cpsi)), void fraction, surface to volume ratio, and hydraulic diameters are illustrated. Cell densities of monolithic structures can vary significantly (e.g., 25-600 cpsi)) as well as void fraction e.g., 35%-73%. Depending on cost, acceptable bed pressure drop, and the intended process for which the structures are to be used, monolithic structures have typically not been competitive with packed beds of particles in the production of high purity VPSA O₂. For example and as evident from FIGS. 1(a) and 1(c), the square monolithic structure shown in FIG. 1(a) has a cell density less than that of FIG. 1(c).

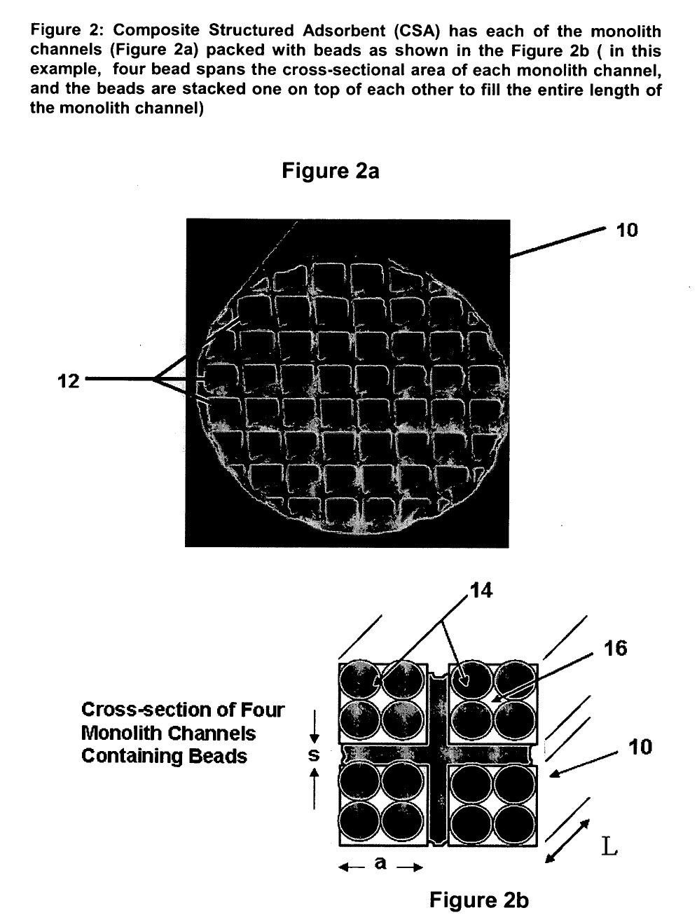

Reference is now made to FIGS. 2(a) and 2(b), in which an embodiment of the present invention will be discussed. FIG. 2(a) illustrates a multi-channel framework structure 10 having a plurality of monolith channels 12. Multi-channel framework 10 can be formed from a variety of materials and in a variety of configurations, for example the desired materials may be in the form of honeycomb extrudates of ceramics, various inorganic oxides, metals, or washcoats on a honeycomb substrate (e.g, metallic). In alternative and in some preferred embodiments, the multi-channel framework 10 can be formed from adsorbent material(s) that are extruded in a honeycomb structure. Preferred materials for some such embodiments can include, but are not limited to, alumina, LiX, CaX, and other ion exchanged zeolites such as NaX zeolites (e.g., 13X), or mixed cation zeolites such as NaLiX, NaCaX and combinations thereof. The material of construction of multi-channel framework 10 can be porous or non-porous. It will be appreciated that the material(s) of construction can vary depending on the process being used, the gas being purified and the like.

In some embodiments, preferred adsorbent material for the construction of the multi-channel framework can include highly exchanged sodium zeolites X having a framework SiO₂/Al₂O₃ (i.e., silica/alumina) ratio between 2.0 and 2.5 having at least 88% and preferably at least 95% of their AlO₂ tetrahedral units associated with lithium cations. Preferred among the foregoing are those having a silica/alumina ratio as close to 2.0 as possible and as high a lithium exchange as possible.

In still other alternative embodiments, equilibrium-selective adsorbent materials, including but not limited to, A-zeoilite, X-zeolite, Y-zeolite, chabazite, mordenite, and various ion exchanged forms of these, as well as silica-alumina, silica, titantium silicates, phosphates and mixtures thereof may be suitable for use for the multi-channel framework.

The multi-channel framework 10 may also include a binder or the like. For more detail as to the manufacture of monoliths reference is made to U.S. Pat. No. 6,284,705 B1 to Park et al.; U.S. Pat. No. 6,521,019 B2 to Jain et al.; U.S. Pat. No. 5,660,048 to Belding et al.; U.S. Pat. No. 5,650,221 to Belding et al.; U.S. Pat. No. 5,685,897 to Belding et al.; U.S. Pat. No. 5,580,367 to Fife; and U.S. Pat. No. 4,012,206 to Macriss et al.; all of which are incorporated herein by reference.

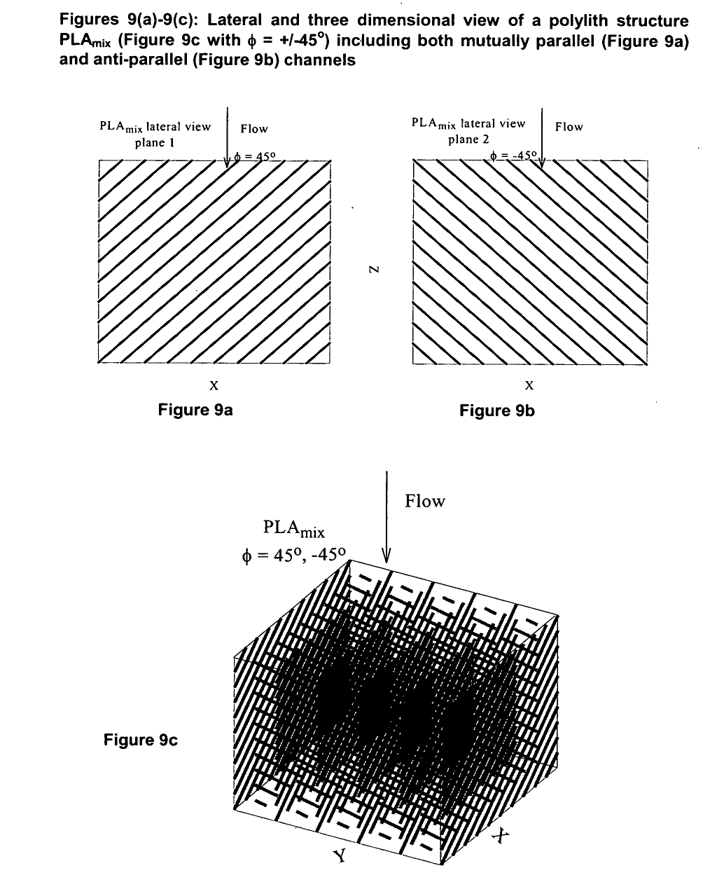

The plurality of channels 12 in framework 10 can be arranged in a variety of configurations. For example and as illustrated in FIG. 2(a), honeycomb multi-channel framework 10 can be formed of many parallel square-shaped monolithic channels. Alternatively, the channels could be circular, hexagonal, triangular or sinusoidal in nature. The multi-channel framework 10 can also be formed of other honeycomb configurations in which the channels are parallel or non-parallel. Other honeycomb structures suitable for use in the invention include, but are not limited to, polylithic structures (see for example FIG. 9(a)-9(c) herein). Those skilled in the art will appreciate that the size of the multi-channel framework will vary depending on the feed gas and the adsorption process.

As shown in FIG. 2(b), each monolith channel 12 contains one or more packed particles 14 in the cross-section of each channel. Space 16 corresponds to the interparticle void within each channel. The channels and particles therein preferably have a channel-to-particle diameter ratio in the range of 1 to 10, more preferably 1 to 7 and even more preferably 1 to 5, in the case of spherical particles (e.g. spherical beads). Various other forms of adsorbent particles can likewise be used in accordance with the present invention. For example, non-spherical beads, granular particles, cylindrical particles or pellets are suitable for use as adsorbent particles within the channels of the multi-channel framework. In situations where the adsorbent particles are non-spherical, the channel-to-particle diameter ratio of 1 to 10, more preferably 1 to 7 and even more preferably 1 to 5 can be determined using a hydraulic diameter of the adsorbent particles. If the value of the channel-to-particle diameter ratio is too high, process performance (for example pressure drop and mass transfer coefficient considerations) may be of concern.

Adsorbent particles 14 can be formed from a variety of adsorbent materials, depending on the intended process and the fluid being processed. While not to be construed as limiting, exemplary adsorbents include, but are not limited to, various ion-exchanged zeolites, activated carbons, silica gels or alumina. Preferred material(s) for some embodiments can include, but are not limited to, alumina, LiX, CaX, and other ion exchanged zeolites such as NaX zeolites (e.g., 13X), or mixed cation zeolites such as NaLiX, NaCaX and combinations thereof. The material(s) of construction for the particles can be porous or non-porous. It will be appreciated that the material(s) of construction can vary depending on the process being used, the gas being purified and the like.

In some embodiments, preferred adsorbent particle material(s) can include highly exchanged sodium zeolites X having a framework SiO₂/Al₂O₃ (i.e., silica/alumina) ratio between 2.0 and 2.5 having at least 88% and preferably at least 95% of their AlO₂ tetrahedral units associated with lithium cations. Preferred among the foregoing are those having a silica/alumina ratio as close to 2.0 as possible and as high a lithium exchange as possible.

In still other alternative embodiments, equilibrium-selective adsorbent materials, including but not limited to, A-zeoilite, X-zeolite, Y-zeolite, chabazite, mordenite, and various ion exchanged forms of these, as well as silica-alumina, silica, titantium silicates, phosphates and mixtures thereof may be suitable for use for the particles. Depending on the application, the adsorbent particles may be the same or different from the adsorbent(s) in the monolith, whether the monolith is formed of adsorbent material (e.g., adsorbent extrudate) or whether the monolith is formed of another material having the adsorbent on the surface thereof as a washcoat.

The adsorbent particles within the channels and the channels of the multi-channel framework are configured such that the channels function in a uniform and symmetrical manner with respect to the other channels in the framework. This is to ensure uniformity of product purity from each channel in the CSA structure. However, various arrangements and configurations are within the scope of the present invention. For example and while not to be construed as limiting, it may be desirable for the end of the channel proximate to the feed end of the adsorbent bed(s) to contain an adsorbent(s) layer or zone for water removal, such as activated alumina while the other end of the channel contains a different adsorbent zone (e.g., 5A or LiX, or CaX or another zeolite) for another desired nitrogen adsorption function to produce high purity oxygen. Additional zones or layers of adsorbent particles may also be used in accordance with the invention. Thus, while the array of particles within a channel may contain different kinds of adsorbents depending on the application and the number and type of impurities to be removed, the channels are configured to function in a uniform manner with respect to one another.

Alternatively, the CSA structure can be assembled in layers of CSAs in accordance with the present invention. For example and while not to be construed as limiting, an illustrative structure could include a first CSA formed of alumina and selective for water removal, a second CSA formed of activated carbon or 13X zeolite for CO₂, and a third CSA formed of zeolite (e.g., 5A, NaX, NaLiX, LiX, CaX or NaCaX) for CO and N₂ removal to produce high purity H₂ from a H₂ containing feed gas (e.g., steam methane reformer). In an alternative embodiment, the monoliths could be formed of an inert material, such as ceramic or an inorganic oxide. Alumina particles (e.g., beads) could be positioned within the channels. Another CSA structure can be positioned for CO₂ removal using activated carbon particles or 13X zeolite in the CSA structure, and a third CSA structure can be positioned for CO and N₂ removal using zeolite (e.g., LiX, CaX, NaCaX, 5A) adsorbent particles.

Referring again to FIG. 2(b) and to 3(a) and 3(b), at least one adsorbent particle 14 is positioned in the cross-section of the channel 12. As discussed herein, depending on the value of N, more than one particle may be positioned in the cross section of the channel. In a preferred embodiment, the length L of the channels 12 is selected such that the particles form an array within each channel 12. While it may not always be necessary to have the array of particles 14 extend the entire length L of channel 12, having unfilled area would likely create some difficulty in the partial filling of adsorbent particles in monolithic structures.

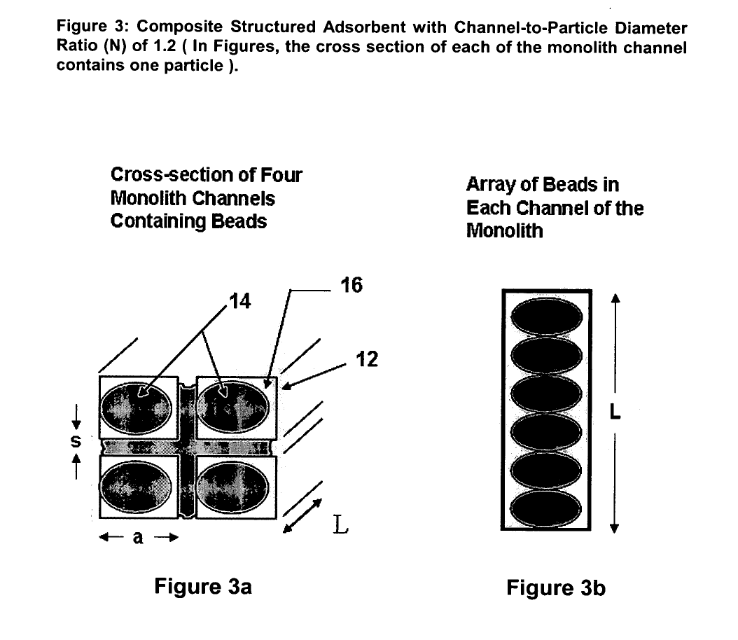

In FIGS. 2b and 3a, the symbol “a” corresponds to the width of the square channel, and the symbol “s” corresponds to the wall thickness of the square channels in the monolithic structure. Thus, the percentage of open area of the square channel monoliths without the adsorbent particles is 100*a²/(a+s)². One of ordinary skill in the art can develop similar expressions to calculate the percentage of open area of non-square channels.

Composite structured adsorbents (CSAs) of the present invention are expected to provide benefits relative to previous packed beds of pellets/beads and monolith configurations. For example, packed beds of beads/pellets generally have good mass transfer coefficients, but tend to exhibit excessive bed pressure drops relative to monoliths. Monoliths tend to exhibit less bed pressure drops relative to packed beds, but generally are characterized by diminished mass transfer coefficients relative to packed beds of pellets/beads.

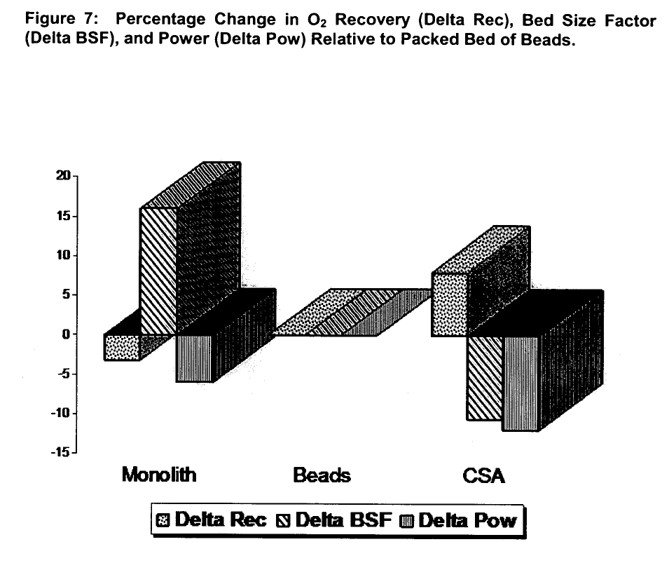

Composite structured adsorbents (CSAs) of the present invention, however, provide advantages of both packed beds of pellets/beads and monoliths. More specifically, the CSAs of the present invention offer improved pressure drop when compared to packed beds of pellets/beads and have better mass transfer coefficients than monoliths for certain values of N. As discussed herein and as evident from FIG. 7, using the CSA material of FIG. 3 with N=1.2 and CSA bed void fraction of 0.4 of the present invention is expected to provide about 8% improvement in O₂ recovery, about 10% reduction in bed size factor (total pounds of adsorbents in the PSA/VPSA beds per ton per day of O₂ produced) and about 12% reduction in power consumption relative to packed beds of pellets or monoliths used in some prior art PSA/VPSA processes.

As mentioned hereinabove, the CSAs of the present invention have a channel-to-particle diameter ratio (N) in the range of 1 to 10, more preferably 1 to 7 and even more preferably 1 to 5. The presence of the multi-channel framework (e.g., monoliths) of the CSA structure induces an ordering of the particles, resulting in higher voidage and lower tortuosity. In addition, by filling or partially filling a plurality of channels (e.g., monoliths or honeycomb) with arrays of adsorbent particles, several disadvantages associated with packed beds of particles or monoliths can be reduced from PSA/VPSA processes. Accordingly, CSA materials of the present invention are expected to have improved separation performance over monoliths or packed beds of particles.

FIGS. 3(a) and 3(b) show a CSA material in accordance with an embodiment of the present invention. In FIGS. 3(a) and 3(b), the ratio of the monolith channel diameter to the particle/bead diameter (N) is 1.2 and the porosity was selected to be 0.4. FIG. 3(a) illustrates a cross-section of a segment of the CSA in which four channels of the monolith containing beads are shown. FIG. 3(b) shows an array of adsorbent beads along the length L of an individual monolithic channel. As can be seen from FIGS. 3(a) and 3(b), the diameter of the bead spans approximately the cross-section area of each channel of the monolith (N=1.2). In the embodiment of FIGS. 3(a) and 3(b), the beads are stacked individually in a linear array throughout the length L of each of the monolithic channels. In the preferred mode of operation, the CSA channel-to-particle diameter ratio (N), defined as the ratio of the diameter of the monolith channel to the diameter of the adsorbent particle (e.g., bead), is greater than 1.0 and less than or equal to 5.0 in the case of spherical particles (e.g. spherical beads). In some embodiments, however, N may be in the range of 1 to 10 so long as the pressure drop does not adversely affect process performance. Various other forms of adsorbent particles can likewise be used in accordance with the present invention. For example, non-spherical beads, granular particles, cylindrical particles or pellets are suitable for use as adsorbent particles within the channels of the multi-channel framework. In situations where the adsorbent particles are non-spherical, the channel-to-particle diameter ratio of 1 to 10, more preferably 1 to 7 and even more preferably 1 to 5 can be determined using a hydraulic diameter of the adsorbent particles.

It is expected that adsorbent vessels and processes can be readily adapted and configured for use with the CSAs of the present invention. For example, an adsorbent vessel can be configured to have at least one adsorbent bed therein, with the at least one adsorbent bed including at least one composite structured adsorbent of the present invention. More specifically, the CSA could include a multi-channel framework, each channel of the multi-channel framework having a length and a cross-section, with each channel containing at least one adsorbent particle positioned in the cross-section of the channel therein. The channels and particles have a channel-to-particle hydraulic diameter ratio in the range of 1 to 10. In the case of some CSAs (e.g., where the framework includes a plurality of monoliths), the channels can be arranged and aligned parallel to the direction of flow of the process gas being treated. In addition, an adsorption process could include feeding a process gas including at least first and second components to an adsorption vessel having at least one adsorbent bed therein, the at least one adsorbent bed having at least one composite structured adsorbent of the present invention therein. More specifically, the CSA would have a multi-channel framework, each channel of the multi-channel framework having a length and a cross-section, each channel containing at least one adsorbent particle positioned in the cross-section of the channel therein, the channels and particles having a channel-to-particle hydraulic diameter ratio in the range of 1 to 10. The process further includes adsorbing at least one component of the process gas in the vessel to form a product gas; and recovering the product gas from the vessel. Those skilled in the art will appreciate that the process may include multiple steps or additional steps.

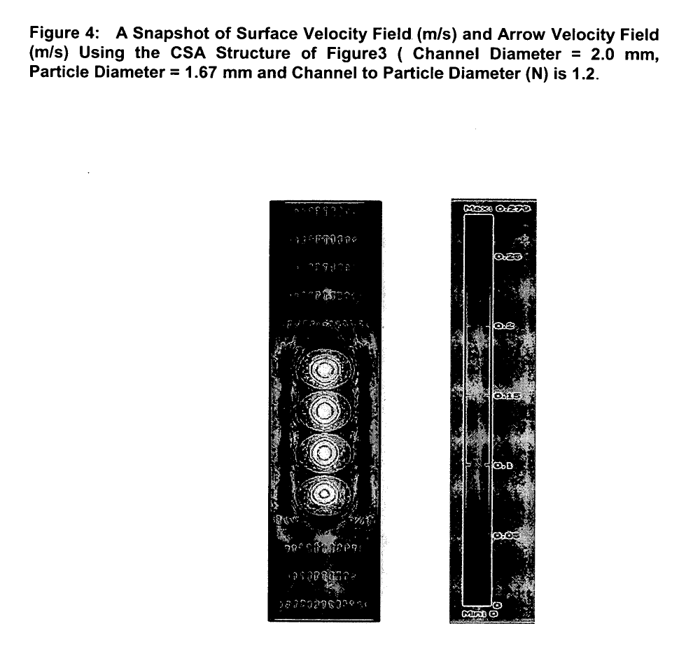

FIG. 4 shows the computational fluid dynamics (CFD) modeling results for one monolithic channel segment of a CSA material having one particle in the cross-section of the channel and a plurality of particles stacked in a serial arrangement along the entire length of the monolithic channel. FIG. 4 shows a snapshot of the surface velocity field (m/s) and the arrow velocity field (m/s) using a CSA structure with monolith channel diameter of 2.0 mm, and particle diameter of 1.67 mm; i.e., N=2.0/1.67=1.2. The computational fluid dynamics (CFD) modeling results illustrated in FIG. 4 indicate that the presence of the monolith wall induces an ordering of the particles, accompanied by a higher voidage and lower tortuosity based on the surface velocity field and arrow velocity field results of FIG. 4.

As is evident in FIG. 4, the fluid path is characterized by substantially uniform flow and is not as tortuous as in typical packed beds of particles. As is further evident from FIG. 4, fluid/gas is forced to contact the wall of the monolith due to the presence of the adsorbent particles (e.g., beads) in the monolith channel.

CSAs including arrays of adsorbent particles in multiple parallel channels (e.g., honeycomb structures such as monoliths) in accordance with the present invention are expected to result in adsorbent beds suitable for use in high frequency processes (e.g., PSA/VPSA) for improved performance and recovery. In some preferred modes of operation of the present invention, adsorption preferably occurs on both the substrate (e.g., extruded adsorbent monolith) and on the adsorbent beads, and the flow path is less tortuous relative to a packed bed of beads. In constructing CSA materials of the present invention, lower cell density (e.g., 100 cpsi) monoliths could be used with higher values of N, resulting in potentially lower cost. In addition, some embodiments of the present invention will allow smaller diameter (e.g., 1.0 mm) particles (e.g., beads) to be used in the monolith channels relative to packed bed of beads where the fluid path would be highly tortuous without the beads or the use of smaller beads (e.g., 1.0 mm) would result in excessive bed pressure drop without the monoliths.

In one preferred mode of operation and as discussed hereinabove, the CSA materials of the present invention include a plurality of monolith channels with each channel having at least one particle in the cross-section of the channel and further include an array of such particles filling the length of each monolith channel. The channel-to-particle diameter preferably has a ratio (N) of 1-5.

For purposes of illustration and comparison, computer simulations were carried out for both packed beds and monolithic configurations as well as for CSAs in accordance with the present invention. More specifically, computer simulated comparisons were conducted using the two-bed arrangement and 12-step VPSA cycle disclosed in U.S. Pat. No. 6,010,555 to Smolarek et al. In the comparison of VPSA performance using beads, monoliths, and CSA, the VPSA cycle, bed pressure profile, operating conditions and the like were used as in U.S. Pat. No. 6,010,555. The only variable in the comparative simulated analyses was the use of different adsorbent structures (e.g., particles, monoliths, and CSA) in the two bed system disclosed in U.S. Pat. No. 6,010,555. The VPSA process has multiple steps in the VPSA cycle and employs simultaneous equalization and evacuation steps followed by simultaneous feed and product pressurization steps. According to the reference, the adsorption and desorption pressures are characterized by a low pressure ratio and relatively high desorption pressure values.

For the computer simulation comparisons, the packed beds included particles of a commercial version of a highly exchanged (>95%) LiX zeolite having a silica to alumina ratio in the range of as close to 2.0 as possible. The particles were spherical and had a diameter of about 1.67 mm. In this simulated comparison, a layer of alumina beads was used at the feed end for H₂O and CO₂ removal, and LiX zeolite beads were used for nitrogen removal to produce oxygen.

For the monolithic structure simulated comparison, an extruded multi-channel framework of LiX zeolite monolith formed of the same adsorbent as that used in the packed beds (a commercial version of a highly exchanged (>95%) LiX zeolite having a silica to alumina ratio in the range of as close to 2.0 as possible) was used. The cell density of the monolithic structure was 200 cpsi. In this simulated comparison, a layer of alumina beads was used at the feed end for H₂O and CO₂ removal, and LiX zeolite extruded monolith was used for nitrogen removal to produce oxygen. The simulation results indicate that the monolith could not make 90% in the two bed VPSA process simulation of U.S. Pat. No. 6,010,555.

The CSA used in the simulated comparison was an extruded multi-channel framework of LiX zeolite monolith containing LiX zeolite beads, both formed of the same adsorbent as that used in the packed beds (a commercial version of a highly exchanged (>95%) LiX zeolite having a silica to alumina ratio in the range of as close to 2.0 as possible). The resulting CSA structure has a value of N=1.2 and porosity of 0.4. The particles within the CSA structure were spherical and had a diameter of about 1.67 mm. In this simulated comparison, a layer of alumina beads was used at the feed end for H₂O and CO₂ removal and the extruded CSA was used for nitrogen removal to produce oxygen.

In the simulations, the same VPSA cycle and process conditions of Smolarek et al., U.S. Pat. No. 6,010,555 were used. The differences in the simulations were with regard to the internals of the adsorbent beds.

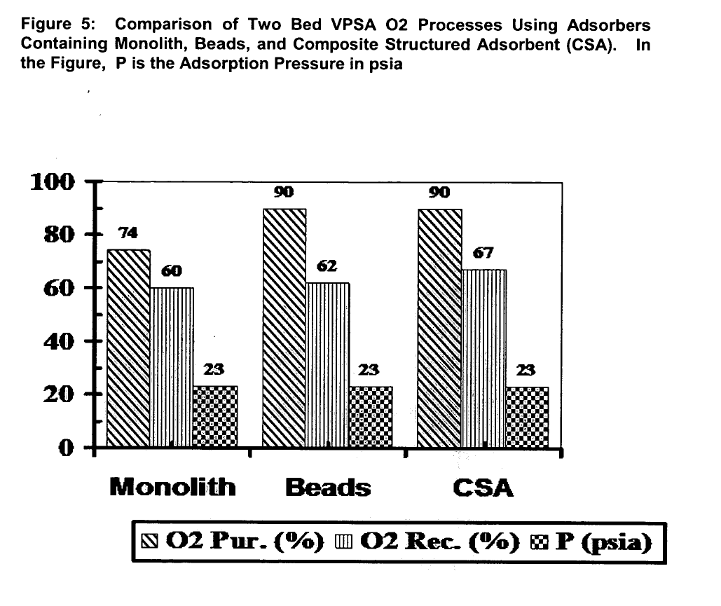

FIG. 5 shows a comparison of the results of the computer simulations of the two-bed VPSA O₂ process of U.S. Pat. No. 6,010,555. As is evident in FIG. 5, only about 74% purity O₂ was achieved using the monolithic adsorbent while 90% O₂ purity was achieved using the packed beads and CSA configurations.

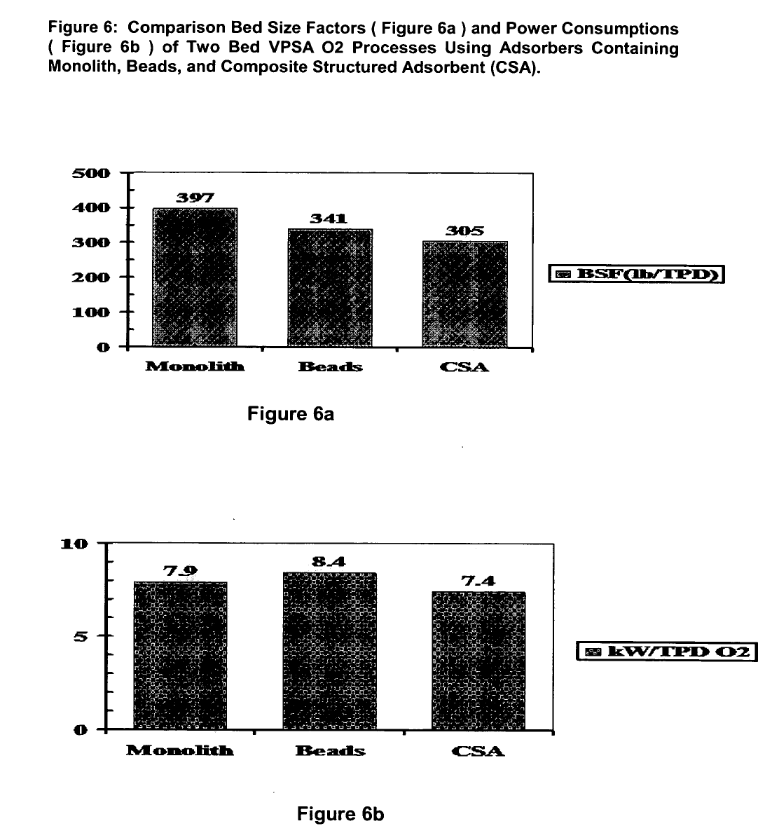

FIGS. 6(a) and 6(b) respectively show comparisons of the bed size factors (BSFs) (total pounds of adsorbents per ton per day O₂) and the corresponding power consumptions for the computer simulated adsorbers using monolith, packed beds of 1.67 mm beads, and CSA materials. As shown from FIGS. 6(a) and 6(b), the computer simulations for the CSA of the present invention had a lower bed size factor (BSF) and a lower power consumption than the computer simulations for both the monolith and the packed beds.

FIG. 7 shows the percentage change in O₂ recovery (i.e., Delta Rec.), bed size factor (i.e., Delta BSF) and power (i.e., Delta Pow) relative to packed beds of beads for the computer simulated comparisons set forth hereinabove. As is evident in FIGS. 5-7, the computer simulated CSA material of this invention provides about 8% increase in O₂ recovery (67% versus 62% using beads), about 10.5% reduction in bed size factor (305 versus 341 lb/TPD O₂), and about 11.9% reduction in power consumption (7.4 versus 8.4 kW/TPD O₂) relative to packed beds of pellets using the cycle described in U.S. Pat. No. 6,010,555. It is also noted and is evident from FIGS. 5-7 that the computer simulated comparative analyses for the monolithic adsorbents exhibited inferior separation performance (e.g., lower O₂ recovery).

The discussion hereinabove has focused on one bead in the cross-section of each monolithic channel of the multi-channel framework of the CSA. In other aspects of the present invention, one or more adsorbent particles can be selected so as to occupy the cross-section of each channel of the monolith. In particular and depending on the size of the adsorbent particles and the respective channel, each monolith channel could be packed with more than one adsorbent particles (e.g., 2, 3, 4, 5, 6, 7, 8) occupying the cross section of each channel. The number of particles in a cross-section is preferably the same for all the channels in a given CSA. As discussed hereinabove, this is to insure uniformity of the product. Once the desired channel-to-particle diameter ratio (N) is selected for a given cycle, specified bed pressure profile, and PSA/VPSA operating conditions, then the CSA will contain repeated layers of 1 or more adsorbent particles in the cross-section of each channel for a portion or the entire length L of the CSA.

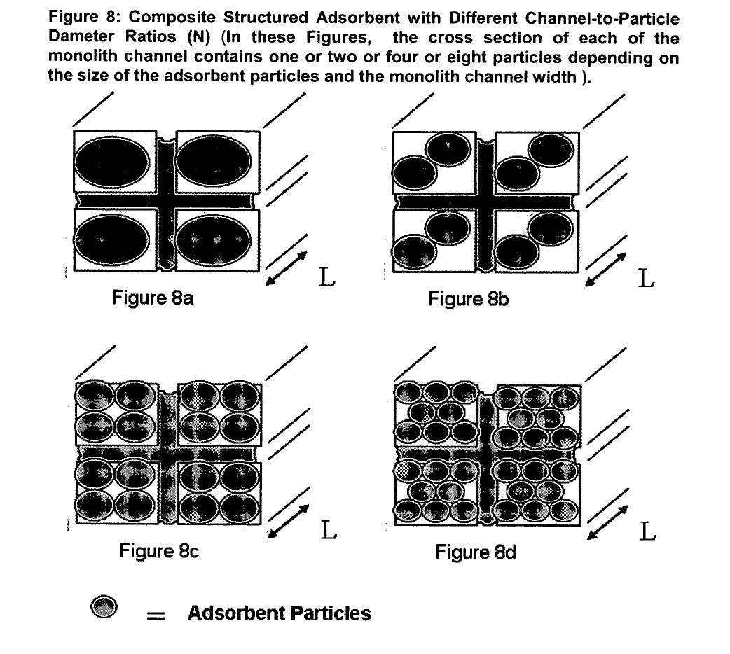

FIGS. 8(a)-8(d) show various composite structured adsorbents with different channel-to-particle diameter ratios (N). In FIGS. 8(a)-8(d), the cross section of each of the monolith channels respectively contains one, two, four or eight beads/particles, depending on the size of the adsorbent particles and the diameter of the monolithic channel width. One can determine an appropriate value of N based on the process and system being used, the gas being treated, the adsorbent(s) as well as computational fluid dynamics (CFD) modeling.

By selecting an appropriate value of N and the particle size, the channel size can then be calculated. The CSA structures could then be selected to achieve improved performance in various fixed bed processes. In addition, the monolithic structure used for constructing the CSA materials could be composed of single solid devices having many parallel channels that may be circular, hexagonal, square, triangular or sinusoidal. Moreover, parameters such as cell density, geometric surface area, bed void fraction, hydraulic diameter, void fraction of catalyst or adsorbent, characteristic diffusion length and the like can be selected for a given feed gas composition and process operating conditions.

In yet other embodiments of the present invention, alternative honeycomb multi-channel framework structures can be utilized. For example, polylithic adsorbents are also expected to be suitable for use as composite structured adsorbent (CSA) materials in PSA/VPSA processes. In contrast to monoliths, polyliths are single solid devices containing both mutually parallel and mutually anti-parallel channels. In one embodiment using polylithic structures, the polylith could include an arrangement of parallel and anti-parallel rods with each rod being a substrate having one or more adsorbents coated on the surface of the rod in the form of a washcoat. The rods could alternatively be formed of the adsorbent material(s). In yet other embodiments using polylithic structures, the polylith could include an arrangement of parallel and anti-parallel sheets (e.g., corrugated sheets) with each sheet being a substrate having one or more adsorbents coated on the surface of the sheet in the form of a washcoat. Alternatively, adsorbent particles could be packed between the sheets of the structure rather than having the adsorbent deployed in the form of a washcoat. The sheets could alternatively or additionally be formed of the adsorbent material(s).

FIGS. 9(a)-9(c) illustrate an example of a polylithic adsorbent (PLA) structure (FIG. 9(c)) including both mutually parallel (FIG. 9a) and mutually anti-parallel channels (FIG. 9b). More specifically, FIGS. 9(a)-9(c) show lateral and three dimensional views of a PLAₘᵢₓ (with φ±45°) polylithic embodiment in accordance with the present invention. It will be understood that PLAₘᵢₓ is the combination of parallel and anti-parallel channels shown in FIG. 9c. As shown and as discussed above, the polylithic adsorbent (PLA) includes layered arrangements of rods, with the angle of alignment of rods of any given layer different from the alignment of rods of the layers immediately next to it. In the example provided in FIGS. 9(a)-9(c), the polylithic adsorbent includes arrangement of rods alternating between φ=+45° (FIG. 9a), and φ=−45° (FIG. 9b). It will also be understood that the magnitudes of φ can be from 0 to 90° based on the desired pressure drop of the resulting structure.

Although the CSA materials discussed hereinabove have focused on the production of O₂ from air using two-bed VPSA processes, more or less number of beds could be used in the VPSA O₂ process. In addition, each bed could include one or several layers of CSA adsorbents (e.g. different adsorbents packed at the bottom, middle, and the upper section of each channel). It is also within the scope of the invention to use CSA materials in other PSA and VPSA processes than the exemplary processes discussed hereinabove. Additionally, the CSA materials could be used with other gas separation processes (e.g., H₂ purification using SMR feed). It is further expected that the materials of the present invention could be used for desired product or co-product production of O₂ and N₂ from air, for the recovery H₂ and CO or CO₂ from blast furnace gases or for various industrial applications such as H₂ PSA, VPSA O₂, TSA, steam iron processes and the like.

In other embodiments of the present invention, the plurality of channels may be formed with a square finned configuration, with or without adsorbent particles therein. Such a configuration is shown for example in FIG. 1b. The finned monolith would preferably be formed of the adsorbent material(s). In such embodiment, the fins within the channel are to be configured so as to provide ordering of the particles, resulting in higher voidage and lower tortuosity.

It should be appreciated by those skilled in the art that the specific embodiments disclosed above may be readily utilized as a basis for modifying or designing other structures for carrying out the same purposes of the present invention. It should also be realized by those skilled in the art that such equivalent constructions do not depart from the spirit and scope of the invention as set forth in the appended claims.

What is claimed is:

1. A composite structured adsorbent, comprising:
a multi-channel framework, each channel of the multi-channel framework having a length and a cross-section, each channel containing at least one adsorbent particle positioned in the cross-section of the channel therein, the channels and particles having a channel-to-particle hydraulic diameter ratio in the range of 1 to 10.

2. The composite structured adsorbent of claim 1, wherein the channels include a plurality of adsorbent particles therein, the plurality of particles forming an array of particles extending along at least a portion of the length of the channels.

3. The composite structured adsorbent of claim 2, wherein the channels and particles positioned within the channels are configured such that the channels function in a uniform and symmetrical manner with respect to the other channels and particles in the framework.

4. The composite structured adsorbent of claim 3, wherein the channels have a cross-sectional area in the shape of cross-sectional areas selected from the group consisting of: circular, hexagonal, square, triangular, sinusoidal and combinations thereof.

5. The composite structured adsorbent of claim 4, wherein the channels comprise a circular cross-sectional area.

6. The composite structured adsorbent of claim 4, wherein the channels comprise a hexagonal cross-sectional area.

7. The composite structured adsorbent of claim 4, wherein the channels comprise a square cross-sectional area.

8. The composite structured adsorbent of claim 4, wherein the channels comprise a triangular cross-sectional area.

9. The composite structured adsorbent of claim 4, wherein the channels comprise a sinusoidal cross-sectional area.

10. The composite structured adsorbent of claim 1, wherein the channel-to-particle hydraulic diameter is from 1 to 7.

11. The composite structured adsorbent of claim 1, wherein the channel-to-particle hydraulic diameter is from 1 to 5.

12. The composite structured adsorbent of claim 2, wherein the array of particles in the channels extend along substantially the entire length of the channels.

13. The composite structured adsorbent of claim 12, wherein the channels have a cross-sectional area in the shape of cross-sectional areas selected from the group consisting of: circular, hexagonal, square, triangular, sinusoidal and combinations thereof.

14. The composite structured adsorbent of claim 12, wherein the channel-to-particle hydraulic diameter is from 1 to 5.

15. The composite structured adsorbent of claim 1, wherein the multi-channel framework comprises a honeycomb structure.

16. The composite structured adsorbent of claim 15, wherein the honeycomb structure comprises a plurality of monolith channels.

17. The composite structured adsorbent of claim 16, wherein the plurality of monolith channels are configured to be substantially parallel to one another.

18. The composite structured adsorbent of claim 17, wherein the channels have a cross-sectional area in the shape of cross-sectional areas selected from the group consisting of: circular, hexagonal, square, triangular, sinusoidal and combinations thereof.

19. The composite structured adsorbent of claim 18, wherein the channel-to-particle hydraulic diameter is from 1 to 5.

20. The composite structured adsorbent of claim 15, wherein the honeycomb structure comprises a polylithic structure.

21. The composite structured adsorbent of claim 20, wherein the polylithic structure comprises a plurality of parallel and anti-parallel sheets.

22. The composite structured adsorbent of claim 1, wherein the plurality of channels further include adsorbent material embedded or coated on the surface of the channels.

23. The composite structured adsorbent of claim 1, wherein the bed void fraction of the CSA structure is between about 0.3-0.8.

24. The composite structured adsorbent of claim 23, wherein the bed void fraction of the CSA structure is between about 0.3-0.6.

25. The composite structured adsorbent of claim 24, wherein the bed void fraction of the CSA structure is between about 0.35-0.45.

26. The composite structured adsorbents of claim 1, wherein the composite structured adsorbent is positioned in an adsorbent bed and configured for use in a pressure swing adsorption (PSA) process.

27. The composite structured adsorbent of claim 1, wherein the composite structured adsorbent is positioned in an adsorbent bed and configured for use in a vacuum pressure swing adsorption (VPSA) process.

28. A composite structured adsorbent, comprising:
a multi-channel framework, each channel of the multi-channel framework having a length and a cross-section, each channel formed of an adsorbent material and containing at least one adsorbent particle positioned in the cross-section of the channel therein, the channels and particles having a channel-to-particle hydraulic diameter ratio in the range of 1 to 10.

29. The composite structured adsorbent of claim 28, wherein the channels include a plurality of adsorbent particles therein, the plurality of particles forming an array of particles extending along at least a portion of the length of the channels.

30. The composite structured adsorbent of claim 29, wherein the channels and particles positioned within the channels are configured such that the channels function in a uniform and symmetrical manner with respect to the other channels and particles in the framework.

31. The composite structured adsorbent of claim 30, wherein the channels have a cross-sectional area in the shape of cross-sectional areas selected from the group consisting of: circular, hexagonal, square, triangular, sinusoidal and combinations thereof.

32. The composite structured adsorbent of claim 31, wherein the channels comprise a circular cross-sectional area.

33. The composite structured adsorbent of claim 31, wherein the channels comprise a hexagonal cross-sectional area.

34. The composite structured adsorbent of claim 29, wherein the channels comprise a square cross-sectional area.

35. The composite structured adsorbent of claim 31, wherein the channels comprise a triangular cross-sectional area.

36. The composite structured adsorbent of claim 31, wherein the channels comprise a sinusoidal cross-sectional area.

37. The composite structured adsorbent of claim 29, wherein the channel-to-particle hydraulic diameter is between 1 to 7.

38. The composite structured adsorbent of claim 37, wherein the channel-to-particle hydraulic diameter is between 1 to 5.

39. The composite structured adsorbent of claim 29, wherein the array of particles in the channels extend along substantially the entire length of the channels.

40. The composite structured adsorbent of claim 39, wherein the channels have a cross-sectional area in the shape of cross-sectional areas selected from the group consisting of: circular, hexagonal, square, triangular, sinusoidal and combinations thereof.

41. The composite structured adsorbent of claim 39, wherein the channel-to-particle hydraulic diameter is between 1 to 5.

42. The composite structured adsorbent of claim 28, wherein the multi-channel framework comprises a honeycomb structure.

43. The composite structured adsorbent of claim 42, wherein the honeycomb structure comprises a plurality of monolith channels.

44. The composite structured adsorbent of claim 43, wherein the plurality of monolith channels are configured to be substantially parallel to one another.

45. The composite structured adsorbent of claim 44, wherein the channels have a cross-sectional area in the shape of cross-sectional areas selected from the group consisting of: circular, hexagonal, square, triangular, sinusoidal and combinations thereof.

46. The composite structured adsorbent of claim 44, wherein the channel-to-particle hydraulic diameter is between 1 to 5.

47. The composite structured adsorbent of claim 42, wherein the honeycomb structure comprises a polylithic structure.

48. The composite structured adsorbent of claim 47, wherein the polylithic structure comprises a plurality of parallel and anti-parallel sheets.

49. The composite structured adsorbent of claim 28, wherein the bed void fraction of the CSA structure is between about 0.3-0.8.

50. The composite structured adsorbent of claim 49, wherein the bed void fraction of the CSA structure is between about 0.3-0.6.

51. The composite structured adsorbent of claim 50, wherein the bed void fraction of the CSA structure is between about 0.35-0.45.

52. The composite structured adsorbents of claim 28, wherein the composite structured adsorbent is positioned in an adsorption bed and configured for use in a pressure swing adsorption (PSA) process.

53. The composite structured adsorbent of claim 28, wherein the composite structured adsorbent is positioned in an adsorption bed and configured for use in a vacuum pressure swing adsorption (VPSA) process.

54. An adsorbent vessel having at least one adsorbent bed therein, the at least one adsorbent bed comprising:
at least one composite structured adsorbent having a multi-channel framework, each channel of the multi-channel framework having a length and a cross-section, each channel containing at least one adsorbent particle positioned in the cross-section of the channel therein, the channels and particles having a channel-to-particle hydraulic diameter ratio in the range of 1 to 10.

55. The vessel of claim 54, wherein the channels include a plurality of adsorbent particles therein, the plurality of particles forming an array of particles extending along at least a portion of the length of the channels.

56. The vessel of claim 55, wherein the channels and particles positioned within the channels are configured such that the channels function in a uniform and symmetrical manner with respect to the other channels and particles in the framework.

57. The vessel of claim 56, wherein the channels have a cross-sectional area in the shape of cross-sectional areas selected from the group consisting of: circular, hexagonal, square, triangular, sinusoidal and combinations thereof.

58. The vessel of claim 54, wherein the channel-to-particle hydraulic diameter is from 1 to 7.

59. The vessel of claim 58, wherein the channel-to-particle hydraulic diameter is from 1 to 5.

60. The vessel of claim 55, wherein the array of particles in the channels extend along substantially the entire length of the channels.

61. The vessel of claim 60, wherein the channels have a cross-sectional area in the shape of cross-sectional areas selected from the group consisting of: circular, hexagonal, square, triangular, sinusoidal and combinations thereof.

62. The vessel of claim 60, wherein the channel-to-particle hydraulic diameter is from 1 to 5.

63. The vessel of claim 54 wherein the multi-channel framework comprises a honeycomb structure.

64. The vessel of claim 63, wherein the honeycomb structure comprises a plurality of monolith channels.

65. The vessel of claim 64, wherein the plurality of monolith channels are configured to be substantially parallel to one another.

66. The vessel of claim 65, wherein the channels have a cross-sectional area in the shape of cross-sectional areas selected from the group consisting of: circular, hexagonal, square, triangular, sinusoidal and combinations thereof.

67. The vessel of claim 66, wherein the channel-to-particle hydraulic diameter is from 1 to 5.

68. The vessel of claim 63, wherein the honeycomb structure comprises a polylithic structure.

69. The vessel of claim 68, wherein the polylithic structure comprises a plurality of parallel and anti-parallel sheets.

70. The vessel of claim 54, wherein the plurality of channels further include adsorbent material embedded or coated on the surface of the channels.

71. The vessel of claim 54, wherein the bed void fraction of the CSA structure is between about 0.3-0.8.

72. The vessel of claim 71, wherein the bed void fraction of the CSA structure is between about 0.3-0.6.

73. The vessel of claim 73, wherein the bed void fraction of the CSA structure is between about 0.35-0.45.

74. The vessel of claim 54, wherein the vessel is configured for use in a pressure swing adsorption (PSA) process.

75. The vessel of claim 74, wherein the PSA process comprises air separation.

76. The vessel of claim 54, wherein the vessel is configured for use in a vacuum pressure swing adsorption (VPSA) process.

77. The vessel of claim 76, wherein the PSA process comprises air separation.

78. An adsorption process, the process comprising:
feeding a process gas comprising at least first and second components to an adsorption vessel having at least one adsorbent bed therein, the at least one adsorbent bed comprising: at least one composite structured adsorbent having a multi-channel framework, each channel of the multi-channel framework having a length and a cross-section, each channel containing at least one adsorbent particle positioned in the cross-section of the channel therein, the channels and particles having a channel-to-particle hydraulic diameter ratio in the range of 1 to 10;
adsorbing at least one component of the process gas in the vessel to form a product gas; and
recovering the product gas from the vessel.

79. The process of claim 78, wherein the channels include a plurality of adsorbent particles therein, the plurality of particles forming an array of particles extending along at least a portion of the length of the channels.

80. The process of claim 78, wherein the channels and particles positioned within the channels are configured such that the channels function in a uniform and symmetrical manner with respect to the other channels and particles in the framework.

81. The process of claim 81, wherein the channels have a cross-sectional area in the shape of cross-sectional areas selected from the group consisting of: circular, hexagonal, square, triangular, sinusoidal and combinations thereof.

82. The process of claim 78, wherein the channel-to-particle hydraulic diameter is from 1 to 7.

83. The process of claim 82, wherein the channel-to-particle hydraulic diameter is from 1 to 5.

84. The process of claim 79, wherein the array of particles in the channels extend along substantially the entire length of the channels.

85. The process of claim 84, wherein the channels have a cross-sectional area in the shape of cross-sectional areas selected from the group consisting of: circular, hexagonal, square, triangular, sinusoidal and combinations thereof.

86. The process of claim 84, wherein the channel-to-particle hydraulic diameter is from 1 to 5.

87. The process of claim 78, wherein the multi-channel framework comprises a honeycomb structure.

88. The process of claim 87, wherein the honeycomb structure comprises a plurality of monolith channels.

89. The process of claim 88, wherein the plurality of monolith channels are configured to be substantially parallel to one another.

90. The process of claim 89, wherein the channels have a cross-sectional area in the shape of cross-sectional areas selected from the group consisting of: circular, hexagonal, square, triangular, sinusoidal and combinations thereof.

91. The process of claim 90, wherein the channel-to-particle hydraulic diameter is from 1 to 5.

92. The process of claim 87, wherein the honeycomb structure comprises a polylithic structure.

93. The process of claim 92, wherein the polylithic structure comprises a plurality of parallel and anti-parallel sheets.

94. The process of claim 78, wherein the plurality of channels further include adsorbent material embedded or coated on the surface of the channels.

95. The process of claim 78, wherein the bed void fraction of the CSA structure is between about 0.3-0.8.

96. The process of claim 95, wherein the bed void fraction of the CSA structure is between about 0.3-0.6.

97. The process of claim 96, wherein the bed void fraction of the CSA structure is between about 0.35-0.45.

98. The process of claim 78, wherein the process comprises a pressure swing adsorption (PSA) process.

99. The process of claim 98, wherein the PSA process is used for air separation.

100. The process of claim 98, wherein the PSA process is used for hydrogen purification.

101. The process of claim 98, wherein the PSA process is used for helium recovery from natural gas.

102. The process of claim 98, wherein the PSA process is used for natural gas upgrading to remove carbon dioxide and nitrogen from the natural gas.

103. The process of claim 78, wherein the process comprises a vacuum pressure swing adsorption (VPSA) process.

104. The process of claim 103, wherein the VPSA process is used for air separation.

105. The process of claim 103, wherein the VPSA process is used for hydrogen purification.

106. The process of claim 103, wherein the VPSA process is used for helium recovery from natural gas.

107. The process of claim 103, wherein the VPSA process is used for natural gas upgrading to remove carbon dioxide and nitrogen from the natural gas.
